(19) United States
(12) Patent Application Publication
(10) Pub. No.: US 2006/0174045 A1
(43) Pub. Date: Aug. 3, 2006

(54) Bus arbitration method and semiconductor apparatus

(76) Inventors: Takashi Maeda, Amagasaki-shi (JP); Mamoru Sumida, Takatsuki-shi (JP); Takuji Kioka, Takatsuki-shi (JP)

Correspondence Address: MCDERMOTT WILL & EMERY LLP, 600 13TH STREET, N.W., WASHINGTON, DC, 20005-3096, US

(21) Appl. No.: 11/332,370

(22) Filed: Jan. 17, 2006

(30) Foreign Application Priority Data
Jan. 17, 2005 (JP) 2005-008814

(51) Int. Cl. G06F 13/36; G06F 12/14

(52) U.S. Cl. 710/113; 711/118

(57) ABSTRACT

An access priority in bus arbitration is changed based on a cache hit ratio so as to perform the bus arbitration. In order to perform the bus arbitration, a cache hit ratio measuring device investigates a status of a cache access by a bus master. A bus arbitration managing device changes a priority in a priority storing device based on an information outputted from the cache hit ratio measuring device. Then, a bus arbitration device performs the bus arbitration in accordance with the priority.

### BACKGROUND OF THE INVENTION

1. Field of the Invention

The present invention relates to a bus arbitration method in the case where a plurality of bus masters share a resource and a semiconductor apparatus to which the bus arbitration method is implemented.

2. Description of the Related Art

As shown in FIG. 1, in a semiconductor apparatus in which a plurality of bus masters (A)101 and (B)102 share a resource 104, it becomes necessary to adjust an access with respect to a bus using a bus arbitration apparatus 103.

Hereinafter, a conventional bus arbitration method in the semiconductor apparatus recited in No. 2000-35943 of the Publication of the Unexamined Japanese Patent Applications is described referring to FIG. 28. The semiconductor apparatus comprises a bus master (A)2801, a bus master (B)2802 and a bus arbitration device 2806. The bus arbitration device 2806 comprises a priority storing unit 2804 for retaining a priority in the bus arbitration, a bus arbitration managing unit 2803 for changing the priority in the bus arbitration, and a bus arbitration unit 2805 for performing the bus arbitration based on the priority in the bus arbitration. The bus arbitration managing unit 2803 measures a bus accessing frequency from a bus request signal to thereby change the priority in the bus arbitration.

In the conventional bus arbitration method, the bus accessing frequency is obtained from the bus request, and the priority is thereby changed as described. However, the method is incapable of an immediate response because some latency is generated by the time when the bus request is received from the bus master. Further, it is difficult to detect the generation of a large number of bus requests due to cache refilling generated by IRQ or the like.

### SUMMARY OF THE INVENTION

Therefore, a main object of the present invention is to change a priority in bus arbitration in real time and speedily improve a bus usability.

In order to achieve the foregoing object, in a semiconductor apparatus according to the present invention, the priority in the bus arbitration is changed based on a cache hit ratio of a bus master so as to perform the bus arbitration. Therefore, the semiconductor apparatus according to the present invention comprises at least two bus masters, a cache hit ratio measuring device and a bus arbitration device. The bus masters each comprises a cache for temporarily storing data transmitted and received between themselves and at least a resource, and the bus masters share the resource via at least a bus. The cache hit ratio measuring unit calculates a hit ratio in accesses made to the cache included in at least one of the bus masters. The bus arbitration device performs the bus arbitration between the bus masters and the resource based on the hit ratio calculated by the cache hit radio measuring unit.

According to the present invention, the status of the cache accesses can be grasped before the bus arbitration device receives the access request from the bus master and immediately reflected on the priority in the bus arbitration. As a result, the bus arbitration can be optimally performed at the time.

The present invention is effective for a bus arbitration method for performing the bus arbitration by renewing the priority in the bus arbitration in real time when the bus masters share the resource and a semiconductor apparatus.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 shows a structure where bus masters, a bus arbitration device and a resource are provided.

FIG. 2 is a block diagram illustrating constitutions of a bus arbitration device, bus masters and a resource according to embodiments 1-9 of the present invention.

FIG. 3 shows constitutions of a cache hit ratio measuring device, a bus arbitration managing unit and a priority storing unit according to the embodiment 1.

FIG. 4 shows priority tables in the priority storing unit.

FIG. 5 shows a constitution of a cache hit ratio measuring unit according to the embodiment 2.

FIG. 6 shows a constitution of a bus arbitration managing unit according to the embodiment 2.

FIG. 7 shows a constitution of a cache hit ratio measuring unit according to the embodiment 3.

FIG. 8 shows a constitution of a hit history register including a per-application register designating unit according to the embodiment 3.

FIG. 9 shows a constitution of a hit history register including a user designation register designating unit according to the embodiment 3.

FIG. 10 shows a constitution of a hit history register including a current adjusting unit according to the embodiment 3.

FIG. 11 shows a constitution of a bus arbitration managing unit according to the embodiment 4.

FIG. 12 shows a constitution of a priority conversion table including a per-application table designating unit according to the embodiment 4.

FIG. 13 shows a constitution of a priority conversion table including a user table designating unit according to the embodiment 4.

FIG. 14 shows a constitution of a priority conversion table including a current adjusting unit according to the embodiment 4.

FIG. 15 shows a constitution of a cache hit ratio measuring unit according to the embodiment 5.

FIG. 16 shows a constitution of a cache hit ratio measuring unit according to the embodiment 6.

FIG. 17 shows an exemplary status of an error/hit in cache accesses according to the embodiment 6.

FIG. 18 shows an entire structure according to the embodiment 7.

FIG. 19 shows a constitution of a cache hit ratio measuring unit according to the embodiment 7.

FIG. 20 shows a constitution of a bus arbitration managing unit according to the embodiment 7.

FIG. 21 shows an entire structure according to the embodiment 8.

FIG. 22 shows a constitution of a cache hit ratio measuring unit according to the embodiment 8.

FIG. 23 shows constitutions of a bus arbitration managing unit and a priority storing unit according to the embodiment 8.

FIG. 24 shows an information in a register according to the embodiment 9.

FIG. 25 shows a priority changing method according to the embodiment 9.

FIG. 26 shows the priority changing method according to the embodiment 9.

FIG. 27 shows the priority changing method according to the embodiment 9.

FIG. 28 shows an entire structure when a conventional bus arbitration is performed.

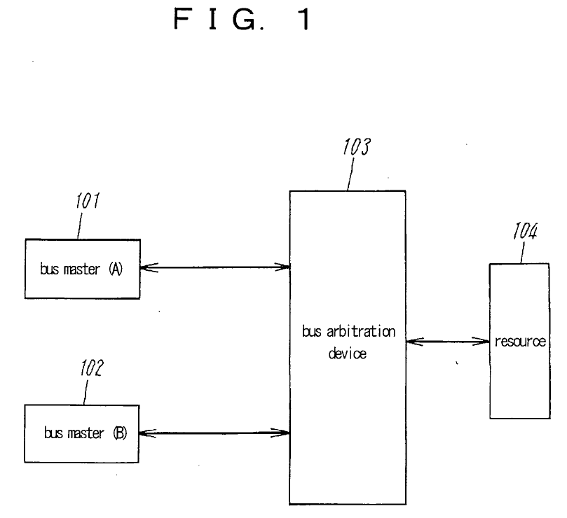

### DETAILED DESCRIPTION OF PREFERRED EMBODIMENTS

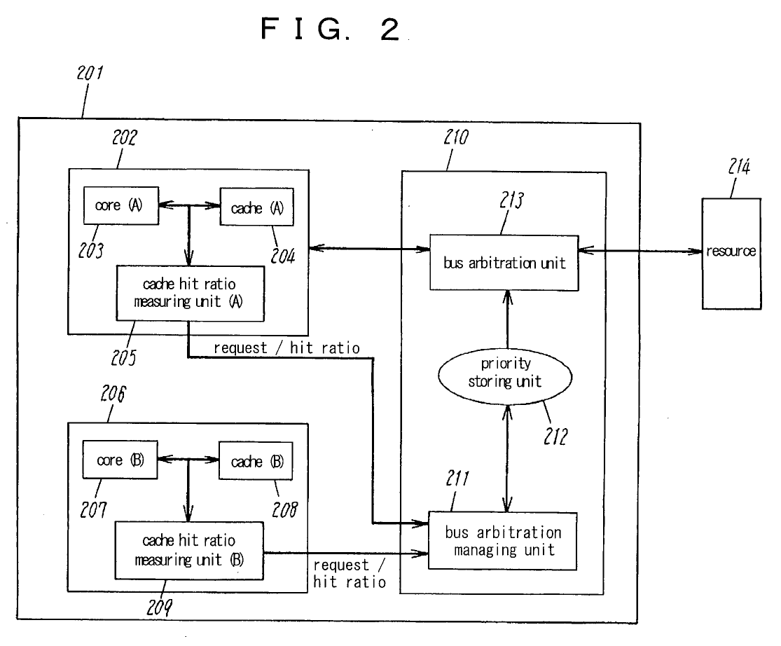

Hereinafter, preferred embodiments of the present invention are described referring to the drawings. FIG. 2 shows an entire structure according to embodiments 1-9 of the present invention. A semiconductor apparatus 201 comprises a bus master (A)202, a bus master (B)206 and a bus arbitration device 210.

The bus master (A)202 and the bus master (B)206 share a resource 214 via the bus arbitration device 210. The bus master (A)202 and the bus master (B)206 respectively comprise a cache (A)204 and a cache (B)208, and a cache hit ratio measuring unit (A)205 and a cache hit ratio measuring unit (B)209.

The cache (A)204 and the cache (B)208 temporarily store data transmitted and received between themselves and the resource 2141. The cache hit ratio measuring unit (A)205 investigates an access status of a core (A)203, an access status of the cache (A)204, and a status of an access made by the core (A)203 with respect to the cache (A)204 and record the investigated statuses therein to thereby measure a relevant cache hit ratio.

In the same manner, the cache hit ratio measuring unit (B)209 investigates an access status of a core (B)207, an access status of the cache (B)208, and a status of an access made by the core (B)208 with respect to the cache (B)208 and record the investigated statuses therein to thereby measure a relevant cache hit ratio.

The bus arbitration device 210 comprises a priority storing unit 212, a bus arbitration managing unit 211 and a bus arbitration unit 213. The priority storing unit 212 retains a priority in bus arbitration. An initial value of the priority in the bus arbitration is previously set by a manufacturer or a user of the semiconductor apparatus and stored in the priority storing unit 212. As the initial value, for example, an equitable and non-prioritized arbitration order is set. The bus arbitration managing unit 211 changes the priority in the bus arbitration in the priority storing unit 212 based on an information outputted from the cache hit ratio measuring unit (A)205 and the cache hit ratio measuring unit (B)209. The bus arbitration unit 213 performs the bus arbitration based on the priority in the priority storing unit 212.

The information outputted from the cache hit ratio measuring unit (A)205 and the cache hit ratio measuring unit (B)209 is a priority raising or lowering request or a coded cache hit ratio.

The hit history register recited in the embodiments of the present invention described below corresponds to a cache access recorder. A hit ratio code table corresponds to a first correspondence relation storage and a second correspondence relation storage. A priority conversion table corresponds to a third correspondence relation storage. However, a priority conversion table 2002 corresponds to a fourth correspondence relation storage. A per-application register designating unit and a user register designating unit correspond to a selector for arbitrarily selecting from a plurality of cache access recorder. A per-application table designating unit and a user table designating unit correspond to a selector for arbitrarily selecting from a plurality of third correspondence relation storages. A hit ratio initializing unit corresponds to an initializer. A pointer corresponds to an indicator.

### EMBODIMENT 1

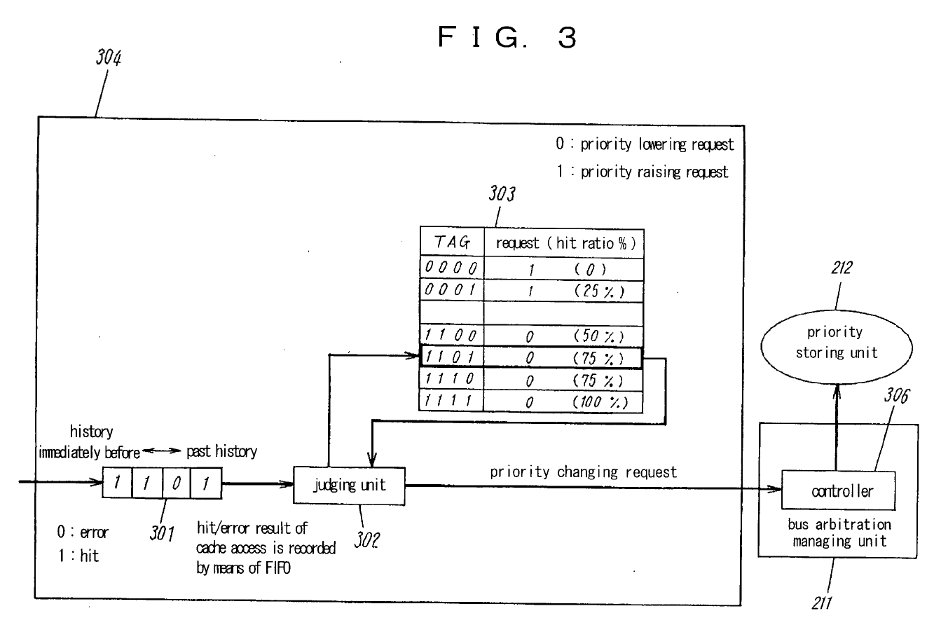

FIG. 2 shows an entire structure of a semiconductor apparatus according to an embodiment 1 of the present invention. FIG. 3 shows constitutions of cache hit ratio measuring units (A)205 and (B)209 and a bus arbitration managing unit 211 according to the embodiment 1. In the embodiment 1, the cache hit ratio measuring units (A)205 and (B)209 basically have a same structure, and these components (A)205 and (B)209 are referred to as a cache hit ratio measuring device 304 in the description below and FIG. 3.

The cache hit ratio measuring device 304 comprises a hit history register 301, a judging unit 302 and a request table 303. The bus arbitration managing unit 211 comprises a controller 306.

Next is described an operation of the semiconductor apparatus according to the embodiment 1. First, the cache accesses are recorded in the hit history register 301 by means of the FIFO method. The accesses are recorded a plurality of times wherein a hit is expressed as “1” and an error is expressed by “0”. In the example shown in FIG. 3, the past four cache accesses are recorded in the hit history register 301 as the hit history.

In the request table 303, the recorded contents of the hit history register 301 (hereinafter, referred to as hit history (TAG)) and the priority changing requests (priority raising or lowering request) are memorized in correspondence with each other in a table format. In the request table 303 according to the embodiment 1, the priority-raising request is memorized as data “1” and the priority-lowering request is memorized as data “0”. In the embodiment 1, the priority-raising request (“1”) corresponds to the hit ratio of below 50%, while the priority-lowering request (“0”) corresponds to the hit ratio of at least 50%. The hit ratio refers to a probability in how many of the cache accesses result recorded in the request table 303 can be the hit (hit probability).

For example, “0000” (0%) and “0001” (25%) correspond to the hit ratio of below 50% in the constitution according to the embodiment 1, while, for example, “1100” (50%), “1101” (75%), “1110” (75%) and “1111” (100%) correspond to the hit ratio of at least 50%.

The judging unit 302 reads the recorded contents of the hit history register 301 (TAG) and checks the read hit history (TAG) against the request table 303 to thereby read a hit ratio changing request (“0” or “1”) corresponding to the hit history (TAG) from the request table 303 and outputs the read changing request to the bus arbitration managing unit 211.

In the example shown in FIG. 3, the recorded contents of the hit history register 301 (TAG) is “1101” (=hit ratio of 75%). Therefore, as the changing request corresponding to the recorded contents (TAG), the judging unit 302 reads the priority-lowering request “0” from the request table 303 and outputs the read request to the bus arbitration managing unit 211. The controller 306 of the bus arbitration managing unit 211 renews the priority in the priority storing unit 212 based on the supplied changing request (priority-lowering request “0” in the present case).

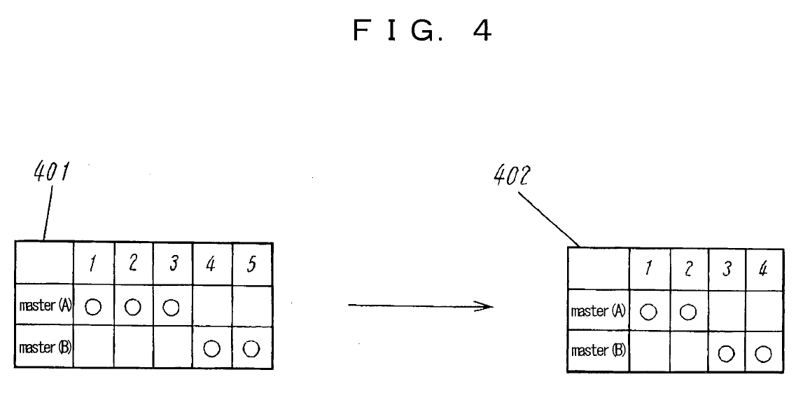

The priority storing unit 212, as shown in FIG. 4, stores the priority table therein and thereby stores the priority. In the priority table in which each section is shown per time slot, the bus master prioritized in each time slot is marked with ◯, and the bus arbitration unit 213 performs the bus arbitration based a certain pattern constituting one cycle. For example, in the case of a current priority table 401, the bus master (A) is prioritized in first three cases (slot numbers 1, 2 and 3) out of five cases, while the bus master (B) is prioritized in the remaining two cases (slot numbers 4 and 5). The foregoing pattern is repeated until the priority table is renewed. For example, when the priority of the bus master (A) is lowered by “1”, the current priority table 401 is renewed into a priority table 402. In the renewed priority table 402, the bus master (A) is prioritized in first two cases out of four cases (slot numbers 1 and 2), while the bus master (B) is prioritized in the remaining two cases (slot numbers 3 and 4). The bus arbitration unit 213 performs the bus arbitration based on the pattern until the priority is renewed.

An upper-limit value and a lower-limit value regarding the priorities are supplied to the controller 306 so that the controller 306 lowers or raises the priority in accordance with the supplied values. As a result, the priority can be prevented from being excessively raised or lowered.

As a result of the foregoing processing, the priority in the bus arbitration is renewed in real time based on the cache hit ratio, which realizes the bus arbitration that is optimum at the time.

### EMBODIMENT 2

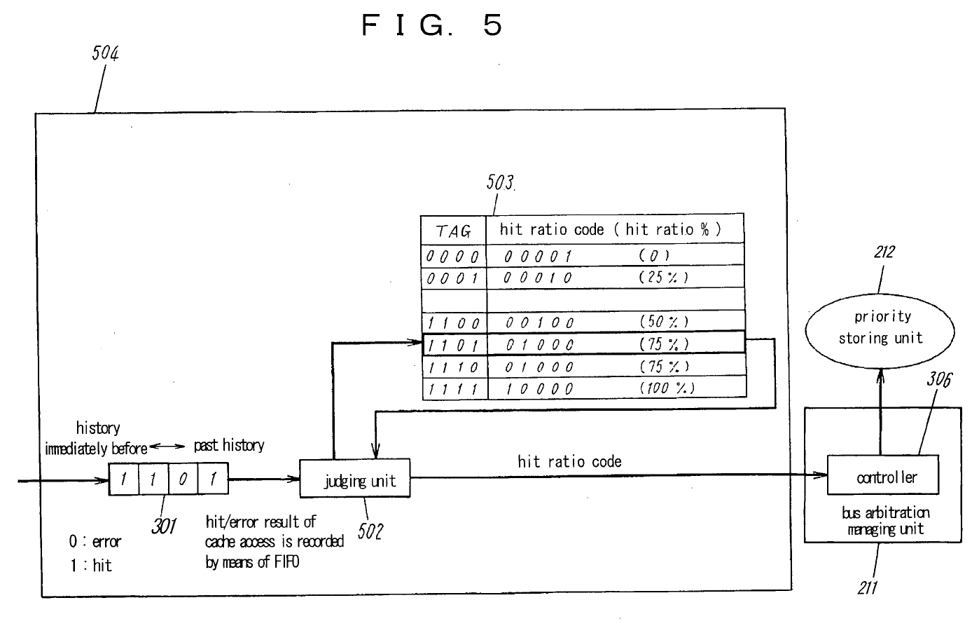

FIG. 2 shows an entire structure of a semiconductor apparatus according to an embodiment 2 of the present invention. A cache hit ratio measuring unit (A)205, a cache hit ratio measuring unit (B)209 and a bus arbitration managing unit 211 according to the embodiment 2 are shown in FIG. 5. The cache hit ratio measuring units (A)205 and (B)209 according to the embodiment 2 basically have a same constitution, and these components are referred to as a cache hit ratio measuring device 504 in the description below and FIG. 5.

As shown in FIG. 5, the cache hit ratio measuring device 504 comprises a hit history register 301, a judging unit 502, and a hit ratio code table 503.

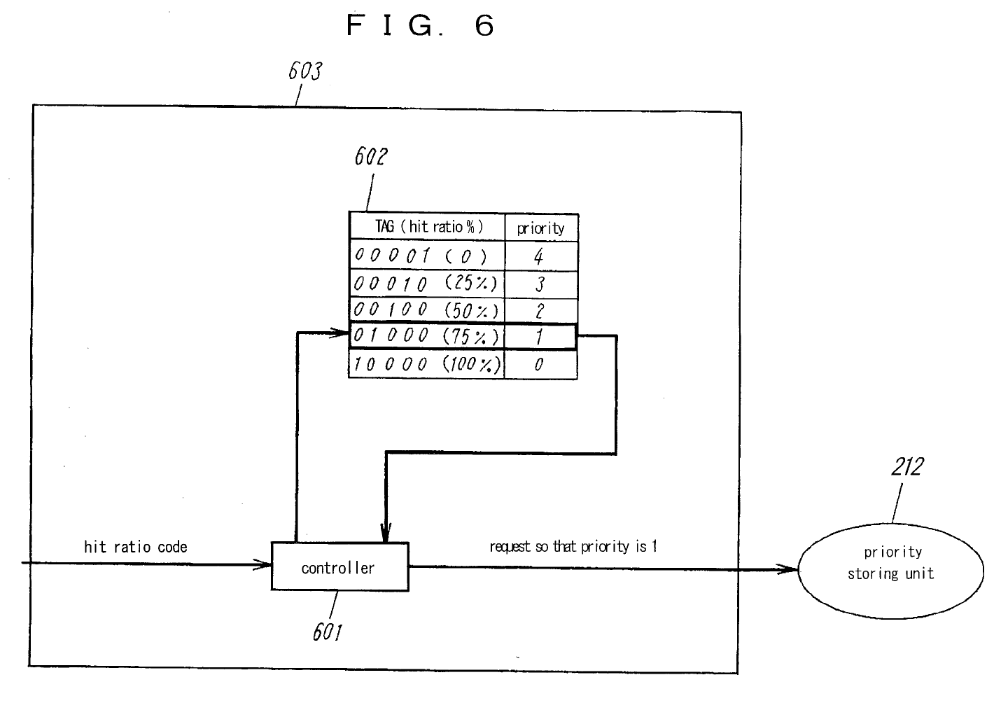

Further, as shown in FIG. 6, the bus arbitration managing unit comprises a controller 601 and a priority conversion table 602.

Next, operations of the foregoing components are described. The cache accesses are stored in the hit history register 301 by means of the FIFO method, wherein the hit is expressed as “1” and the error is expressed by “0”. The judging unit 502 references the hit ratio code table 503, and associates the value recorded in the hit history register 301 (TAG) and the coded hit ratio (hereinafter, referred to as hit ratio code) with each other to thereby read the hit ratio code corresponding to the value (TAG) and output the read hit ratio code to the bus arbitration managing unit 211. Among the hit ratio codes, “00001” indicates the hit ratio of 0%, “00010” indicates the hit ratio of 25%, “00100” indicates the hit ratio of 50%, “01000” indicates the hit ratio of 75%, and “10000” indicates the hit ratio of 100%.

In an example shown in FIG. 5, the value stored in the hit history register 301 (TAG) is “1101”, then, the judging unit 502 references a section in which the value (TAG) indicates “1101” in the hit ratio code table 503. In the present example, the hit ratio code corresponds to the TAG: “1101” is “01000” indicating the hit ratio of 75%. Therefore, the judging unit 502 reads the hit ratio code “01000” from the hit ratio code table 503 and outputs the read code to the bus arbitration managing unit 211.

The controller 601 of the bus arbitration managing unit 211 renews the priority in the priority storing unit 212 based on the supplied hit ratio code. More specifically, the controller 306 references the priority conversion table 602 for the supplied hit ratio code to thereby read the priority corresponding to the hit ratio code from the priority conversion table 602.

In the bus arbitration managing unit 211 shown in FIG. 6 (priority conversion table 602), the hit radio code “00001” (=hit ratio of 0%) corresponds to the priority “4”, the hit radio code “00010” (=hit ratio of 25%) corresponds to the priority “3”, the hit-radio code “00100” (=hit ratio of 50%) corresponds to the priority “2”, the hit-radio code “01000” (=hit ratio of 75%) corresponds to the priority “1”, and the hit-radio code “10000” (=hit ratio of 100%) corresponds to the priority “0”.

In the examples shown in FIGS. 5 and 6, the hit ratio code “01000” is read from the hit ratio code table 503 and supplied to the controller 601. Therefore, the controller 601 reads the priority “1” from the priority conversion table 602. Then, the controller 601 makes a request to the priority storing unit 212 so that the priority is “1”. The priority storing unit 212 renews the priority table based on the request from the controller 601.

The priority table in the priority storing unit 212 and the method of renewing the priority table are the same as described in the embodiment 1. The bus arbitration unit 213 performs the bus arbitration based on the pattern of the priority table.

In the priority conversion table, the hit ratio code and the priority correspond to each other one-on-one in a fixed manner. However, if a function (more specifically, software) for changing the correspondence relation between them is additionally provided (installed) in the controller 601 depending on different processes, the bus arbitration can be optimized in each process.

### EMBODIMENT 3

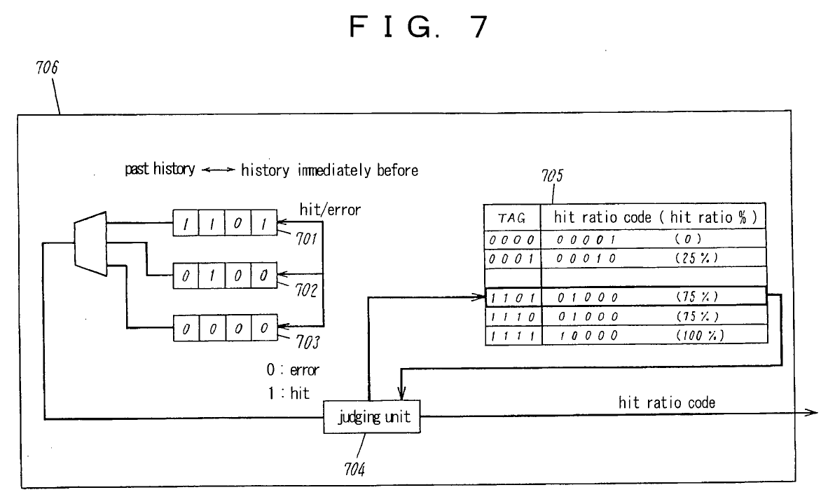

FIG. 2 shows an entire structure of a semiconductor apparatus according to an embodiment 3 of the present invention. A cache hit ratio measuring unit (A)205 and a cache hit ratio measuring unit (B)209 according to the embodiment 3 are basically constituted in the same manner, and referred to as a cache hit ratio measuring device 706 in the description below and FIG. 7.

The ache hit ratio measuring device 706 comprises a plurality of hit history registers 701, 702 and 703, a judging unit 704 and a hit ratio conversion table 705. The cache hit ratio measuring device 706 operates in the same manner as described in the embodiment 2. More specifically, the cache hit ratio measuring device 706 measures the cache hit ratio to thereby read the hit ratio code corresponding to the measured cache hit ratio from a hit ratio code table 705 and output the read hit ratio code to the bus arbitration unit 211.

In the embodiment 3, the plurality of hit history registers 701, 702 and 703 is provided, and they are selectively used for different processes. Thereby, the hit ratio can be accurately measured in each processing. Which of the hit history registers 701, 702 and 703 is to be used can be previously determined or designated by the user via a program.

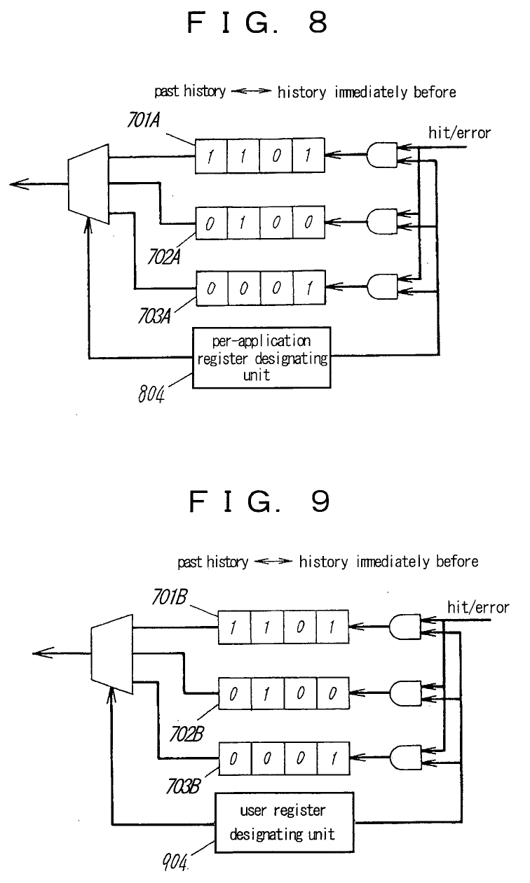

For example, as shown in FIG. 8, a per-application register designating unit 804 for designating which of hit history registers 701A, 702A and 703A should be used in each application (software) to be operated and measuring the cache hit ratio per application may be additionally provided. The per-application register designating unit 804 retains information relating to the application in advance and thereby designates the register not used immediately before the application is changed. The provision of the per-application register designating unit 804 particularly exerts an effect in a state where the application is operated in a multitask manner.

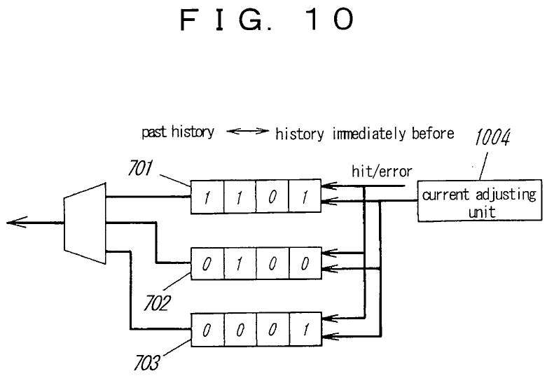

As another example, a use register designating unit 904 for making an adjustment so that the register designated by the user is used may be additionally provided as shown in FIG. 9. The user register designating unit 904 is operated by a program generated by the user in order to designate which of registers 701B, 702B and 703B should be used.

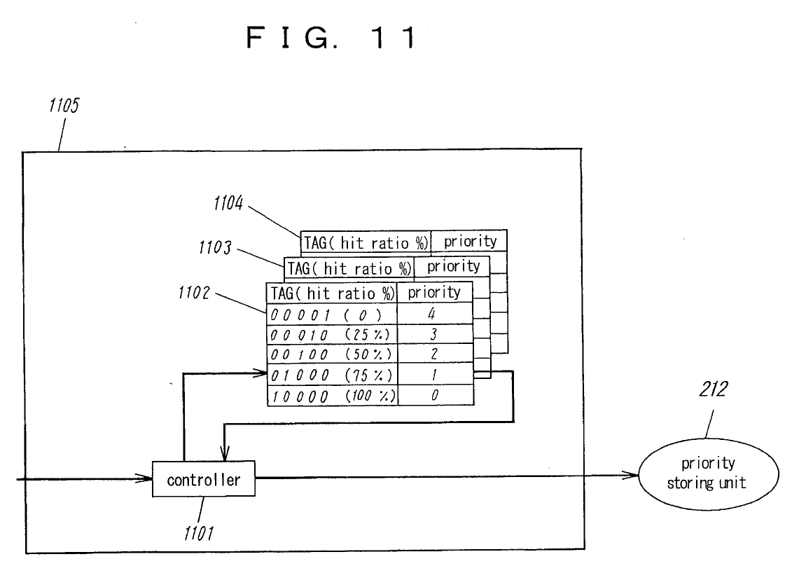

In the constitution according to the embodiment 3 where the plurality of hit history registers 701, 702 and 703 is provided, as shown in FIG. 10, when a current adjusting unit 1004 for adjusting current to be applied to plurality of hit history registers 701, 702 and 703 is additionally provided, power consumption can be reduced in such manner that the current is not applied to any of the hit history registers 701, 702 and 703 that is presently unused.

The bus arbitration managing unit 211 is constituted and operated in the same manner as described in the embodiment 2.

### EMBODIMENT 4

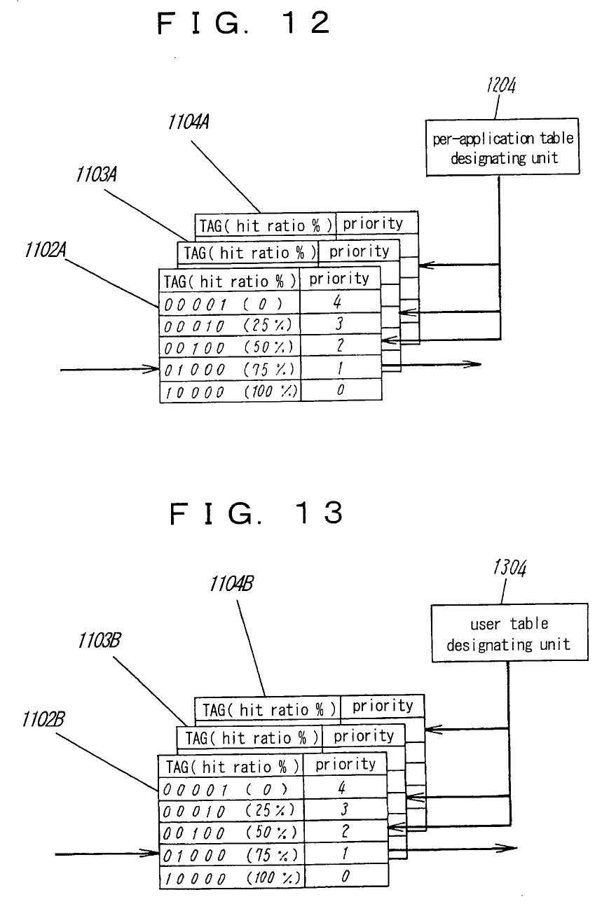

FIG. 2 shows an entire structure of a semiconductor apparatus according to an embodiment 4 of the present invention. The embodiment 4 is characterized in a constitution of a bus arbitration managing unit 1105 shown in FIG. 11. The bus arbitration managing unit 1105 comprises a controller 1101 and a plurality of priority conversion tables 1102, 1103 and 1104.

The controller 1101 references the priority conversion tables 1102, 1103 and 1104 for the hit ratio code to thereby read the priority in accordance with the hit ratio code from the priority conversion tables 1102, 1103 and 1104. The read priority is outputted to the priority storing unit 212 by the controller 1101. The operation for renewing the priority table in the priority storing unit 212 is the same as described in the embodiment 2.

In the embodiment 4, the plurality of priority conversion tables 1102, 1103 and 1104 each reciting a different correspondence relation between the TAG (hit ratio) and the priority is provided, and these priority conversion tables 1102, 1103 and 1104 are selectively used for different processes. Thereby, the priority suitable that is accurate and suitable for each process can be obtained, which optimizes the bus arbitration.

Which of the priority conversion tables 1102, 1103 and 1104 is to be used can be previously determined or designated by the user via a program.

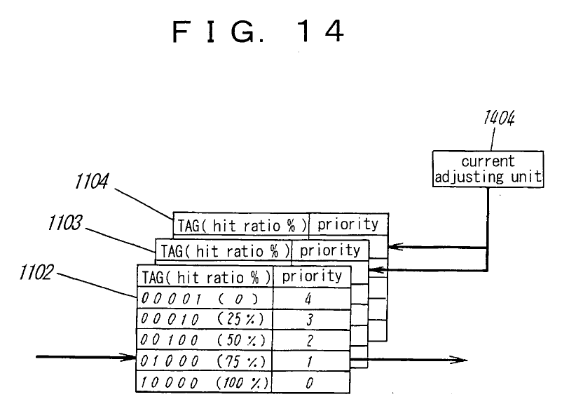

For example, in FIG. 12, a per-application table designating unit 1204 for designating which of priority conversion tables 1102A, 1103A and 1104A should be used per application is provided. The per-application table designating unit 1204 previously retains information regarding the application and thereby designates which of the priority conversion tables 1102A, 1103A and 1104A is to be used when the application is changed.

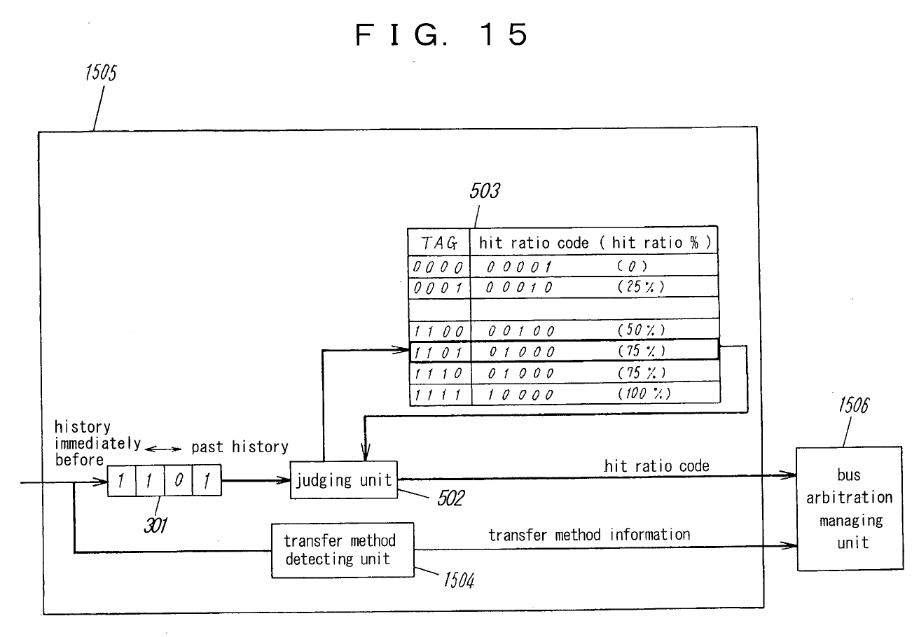

Further, a constitution shown in FIG. 13 is provided with a user table designating unit 1304 for making an adjustment so that any of priority conversion table 1102B, 1103B or 1104B previously designated by the user is used. The user table designating unit 1304 is operated by a program generated by the user in order for the user him/herself to designate which of the priority conversion tables 1102B, 1103B and 1104B is to be used.

Further, when a current adjusting unit 1404 for adjusting current to be applied to the plurality of priority conversion tables 1102, 1103 and 1104 is provided as shown in FIG. 14, the power consumption can be reduced in such manner that the current is not applied to any unused priority conversion table.

The cache hit ratio measuring units 205 and 209 are constituted and operated in the same manner as described in the embodiment 2.

### EMBODIMENT 5

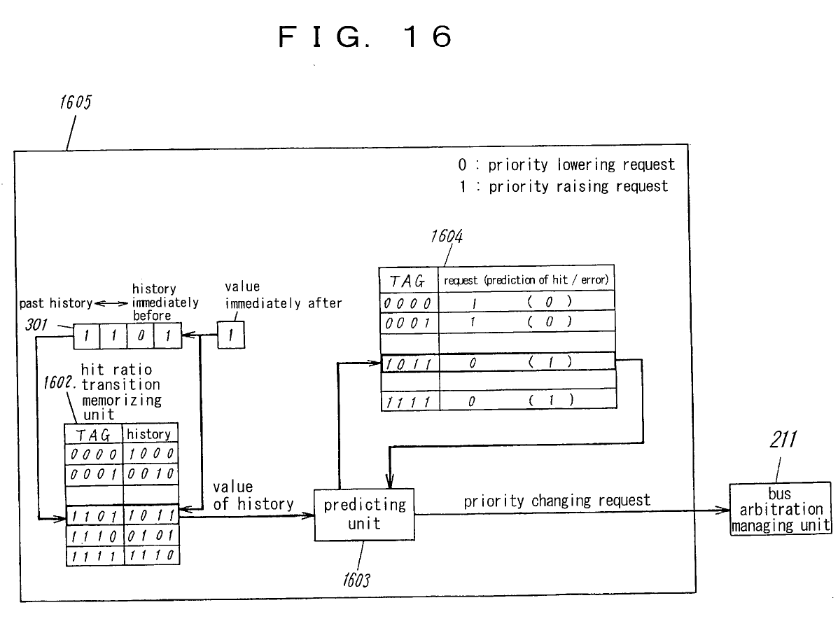

FIG. 2 shows an entire structure of a semiconductor apparatus according to an embodiment 5 of the present invention. The embodiment 5 is characterized in a constitution of a cache hit ratio measuring device 1505 shown in FIG. 15. A cache hit ratio measuring unit (A)205 and a cache hit ratio measuring unit (B)209 according to the embodiment 5 is constituted in the same manner as the cache hit ratio measuring device 1505 shown in FIG. 15. A bus arbitration managing unit 1506 has the same constitution as described referring to FIG. 6 in the embodiment 2, however, is slightly different in its operation.

The cache hit ratio measuring device 1505 comprises a hit history register 301, a judging unit 502, a hit ratio code table 503 and a transfer method detecting unit 1504. The hit history register 301, judging unit 502 and hit ratio code table 503 are constituted and operated in the same manner as described in the embodiment 2.

The embodiment 5 is characterized in that the transfer method detecting unit 1504 is provided. The transfer method detecting unit 1504 detects whether or not a transfer method of the bus master is a single transfer or a burst transfer, and outputs a result of the detection to the bus arbitration managing unit 1506. The single transfer is a transfer method adopted when the data that cannot be stored in the cache is read by the core from the cache, in other words, when a non-cacheable access is generated. The burst transfer is a transfer method adopted when a cache error is generated. In the case of the single transfer, the bus master is only required to access the resource once in order to read the data therefrom, while the bus master is required to access the resource a plurality of times in order to read the data therefrom. Therefore, when the burst transfer is generated, it is necessary to raise the priority of the bus master to be accessed in comparison to the single transfer. Based on the foregoing reason, the burst transfer and the single transfer need to be distinguished from each other.

The bus arbitration managing unit 1506 according to the present embodiment is constituted in the same manner as described in the embodiment 2, however, a controller 601′ is differently operated. The controller 601′ receives an information of the transfer method outputted from the transfer method detecting unit 1504, and, as described in the embodiment 2, requests the priority storing unit 212 to renew the priority table in the case of the burst transfer, while requesting the priority storing unit 212 to set the priority of the priority storing unit 212 to “1” in the case of the single transfer.

In order to make the requests, the controller 601′ controls itself so that the priority of the priority conversion table 602 always references the “1” section when notified of the single transfer by the transfer method detecting unit 1504. Alternatively, the controller 601′ controls itself so as to request the priority storing unit 212 to always set the priority to “1” without referencing the priority conversion table 602.

In the foregoing manner, any unnecessary access to the resource in the single transfer can be prevented, and, as a result, the bus arbitration can be efficiently performed.

### EMBODIMENT 6

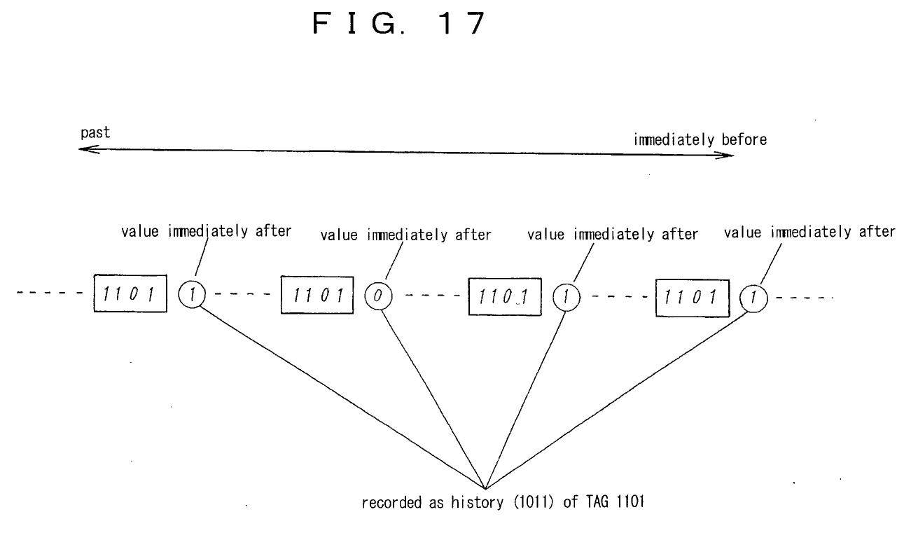

FIG. 2 shows an entire structure of a semiconductor apparatus according to an embodiment 6 of the present invention. The embodiment 6 is characterized in a constitution of a cache hit ratio measuring device 1605 shown in FIG. 16. More specifically, a cache hit ratio measuring unit (A)205 and a cache hit ratio measuring unit (B)209 according to the embodiment 6 are constituted in the same manner as the cache hit ratio measuring device 1605 shown in FIG. 16. The cache hit ratio measuring device 1605 comprises a hit history register 301, a hit transition memorizing unit 1602, a predicting unit 1603 and a request table 1604.

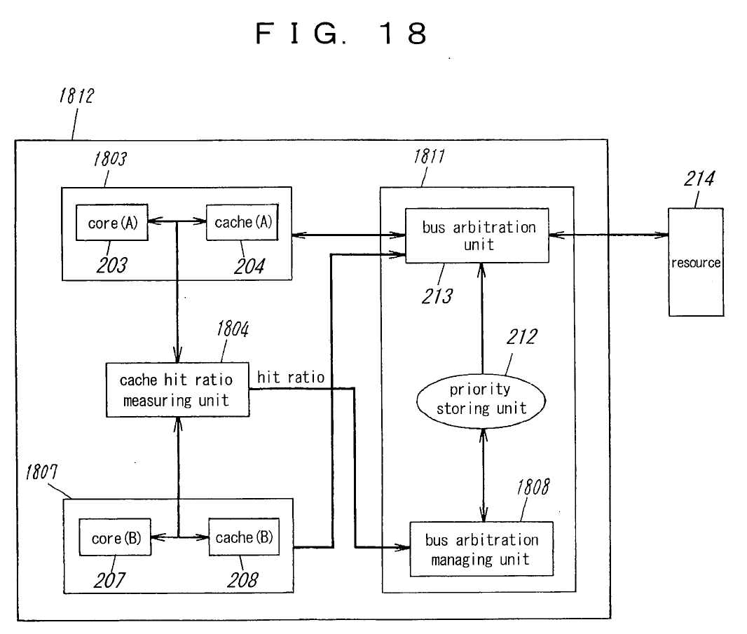

Next, operations of the foregoing components are described. In the hit history register 301, the hit of the cache access is stored as the data “1” and the error is stored as the data “0” by means of the FIFO method. In the hit transition memorizing unit 1602, statuses possibly generated in the hit history register 301 (combinations of 0 and 1) and the last four immediate access statuses corresponding to the possible statuses (hit/error) are recorded. The recorded contents of the hit transition memorizing unit 1602 are described further in detail referring to FIG. 17.

For example, given that a cache access status shown in FIG. 17 is generated, a part where the access combination of the cache hit and the cache error is “1101” is observed, and the transition of “1”→“0”→“1”→“1” can be learnt from observing the last four accesses immediately after the access combination shown in FIG. 17. Based on the result of the foregoing access transition, the hit transition memorizing unit 1602 records “1011 in the history in which the access combination TAG corresponds to the “1101” section.

In the same manner, in the history in which the access combination TAG corresponds to the “0000” section, for example, “1000” is recorded. In the history in which the access combination TAG corresponds to the “10001” section, for example, “0010” is recorded. In the history in which the access combination TAG corresponds to the “11110” section, for example, “0101” is recorded. In the history in which the access combination TAG corresponds to the “1111” section, for example, “1110” is recorded.

Because the status of the cache access is changed, the value of the history in the hit transition memorizing unit 1602 is renewed whenever necessary. The predicting unit 1603 reads the value of the history corresponding to the access combination TAG of the hit history memorizing unit 1602 and references the request table 1604 for the read history.

In the request table 1604, the recorded contents of the hit transition memorizing unit 1602 (hereinafter, referred to as hit transition history (TAG)) and the priority changing requests (priority raising or lowering request) are previously memorized in correspondence with each other in the table format. In the request table 1604 according to the embodiment 6, the priority raising request is memorized as the data “1”, while the priority lowering request is memorized as the data “0”. The foregoing correspondence of the data in the request table 1604 is based on the result of predicting the operation of the core from the hit transition history (TAG). For example, as shown in FIG. 17, when the value of the hit transition history (TAG) is “1011”, the three accesses of the last four accesses immediately after the access combination result “1”, which means that the probability of obtaining the cache hit (hit ratio probability) can be evaluated as high (75%). As a result, it becomes unnecessary for the bus master to access the resource, and the priority lowering request “0” accordingly corresponds to the bus master. In the embodiment 6, as an example of the correspondence relation, the priority raising request “1” corresponds to the hit ratio prediction of below 50%, while the lowering request “1” corresponds to the hit ratio prediction of at least 50%.

The predicting unit 1603 outputs the priority lowering request or the priority raising request read from the request table 1604 to the bus arbitration managing unit 211.

When the future status of the cache access, in other words, whether the cache hit or error is generated, is thus predicted, the bus arbitration that is optimized at the time can be more probably performed.

The bus arbitration managing unit 211 is constituted and operated in the same manner as described in eth embodiment 1.

### EMBODIMENT 7

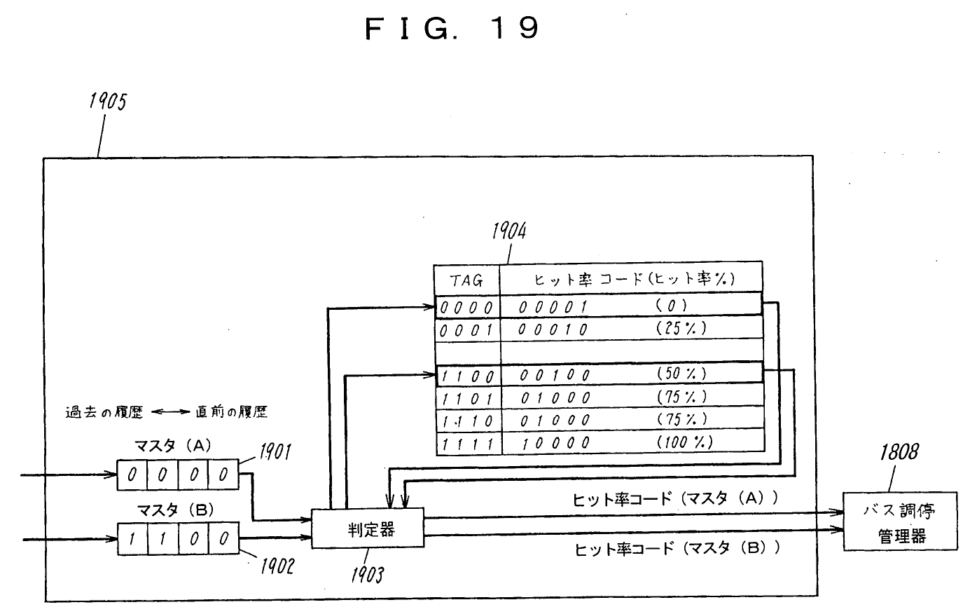

FIG. 18 shows an entire structure of a semiconductor apparatus according to an embodiment 7 of the present invention. A semiconductor apparatus 1812 comprises a bus master (A)1803, a bus master (B)1807, a bus arbitration device 1811 and a cache hit ratio measuring unit 1804. The cache hit ratio measuring unit 1804 simultaneously records and measures the cache hit ratios of the bus master (A)1803 and the bus master (B)1807. The bus masters (A)1803 and (B)1807 share a resource 214 via the bus arbitration device 1811.

The bus master (A)1803 comprises a core (A)203 and a cache (A)204. The bus master (B)1807 comprises a core (B)207 and a cache (B)208. The bus arbitration device 1811 comprises a priority storing unit 212, a bus arbitration managing unit 1808 and a bus arbitration unit 213. The bus arbitration managing unit 1808 renews the priority in the priority storing unit 212 based on an information outputted from the cache hit ratio measuring unit 1804. The bus arbitration unit 213 performs the bus arbitration based on the priority in the priority storing unit 212.

The information outputted from the cache hit ratio measuring unit 1804 is the cache hit ratios of the bus master (A)1803 and the bus master (B)1807. The cache hit ratio is coded in the present embodiment.

A constitution and an operation of the cache hit ratio measuring unit 1804 are described. As shown in FIG. 19, a cache hit ratio measuring device 1905 comprises a hit history register 1901 for the bus master (A)1803, a hit history register 1902 for the bus master (B)1807, a hit ratio code table 1904 and a judging unit 1903. The cache accesses of the bus masters (A)1803 and (B)1807 are stored in the hit history registers 1901 and 1902 by means of the FIFO method, wherein the hit is recorded as the data “1” and the error is recorded as the data

The judging unit 1903 references the hit ratio code table 1904 for the hit history (TAG) recorded in the hit history registers 1901 and 1902 to thereby read the hit ratio code corresponding to the hit history (TAG) from the hit ratio code table 1904 and output the read hit ratio code to the bus arbitration managing unit 1808.

The judging unit 1903 simultaneously outputs the hit ratio codes for the bus masters (A)1803 and (B)1807. The hit ratio code table 1904 is referenced by the judging unit 1903 according to the method described in the embodiment 2.

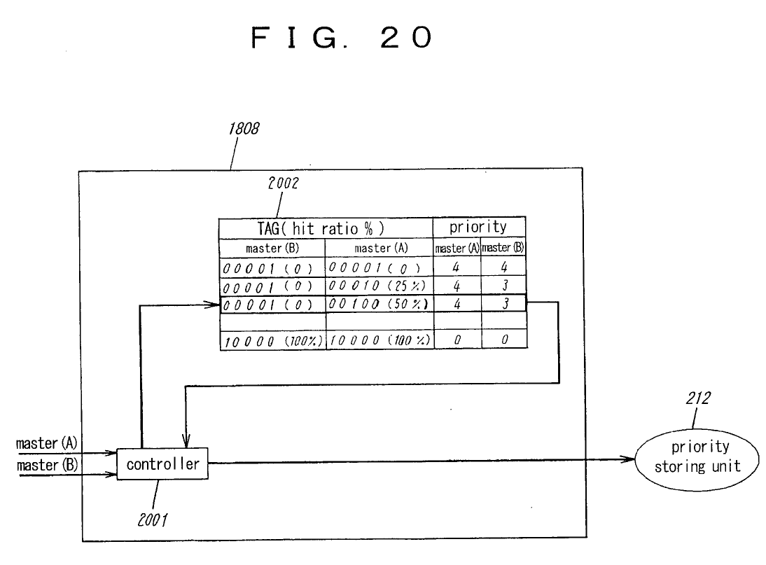

A constitution and an operation of the bus arbitration managing unit 1808 are described. As shown in FIG. 20, the bus arbitration managing unit 1808 comprises a controller 2001 and a priority conversion table 2002. In the priority conversion table 2002, a correspondence relation between a combination of the hit ratio codes and a combination of the priorities is recorded. The combination of the hit ratio codes is the combination of the hit ratio codes of the bus masters (A)1803 and (B)1807. The combination of the priorities is the combination of the priorities of the bus masters (A)1803 and (B)1807.

In a bus arbitration managing unit 2003 shown in FIG. 20 (priority conversion table 2002), the combination of the hit ratio code of the master A, “00001” (=hit ratio of 0%) and the hit ratio code of the master B, “00001” (=hit ratio of 0%) corresponds to the combination (master A: priority “4”), (master B: priority “4”). The hit ratio code of the master A “00001” (=hit ratio of 0%) and the hit ratio code of the master B, “00010” (=hit ratio of 25%) corresponds to the combination (master A: priority “4”) , (master B: priority “3”). The hit ratio code of the master A “00001” (=hit ratio of 0%) and the hit ratio code of the master B, “00100” (=hit ratio of 50%) corresponds to the combination (master A: priority “4”) (master B: priority “3”). The hit ratio code of the master A “10000” (=hit ratio of 100%) and the hit ratio code of the master B, “10000” (=hit ratio of 100%) corresponds to the combination (master A: priority “0”), (master B: priority “0”).

The controller 2001 references the priority conversion table 2002 for the hit ratio codes supplied from the cache hit ratio measuring device 1905 to thereby read the combination of the priorities corresponding to the combination of the hit ratio codes from the priority conversion table 2002 and output the read combination to the priority storing unit 212.

As described, in the embodiment 7, the hit ratio codes of the bus masters (A)1803 and (B)1807 are simultaneously inputted to the controller 2001. In response to that, the combination of the priorities corresponding to the combination of the hit ratio codes of the bus masters (A)1803 and (B)1807 is memorized in the priority conversion table 2002.

Thereby, in the embodiment 7, the cache access statuses of the bus masters (A)1803 and (B)1807 both can be simultaneously taken into account. As a result, the priority can be more accurately provided in real time. The controller 2001 renews the priority in the priority storing unit 212 based on the priority obtained from the priority conversion table 2002. The priority is renewed by means of the method described in the embodiment 2.

### EMBODIMENT 8

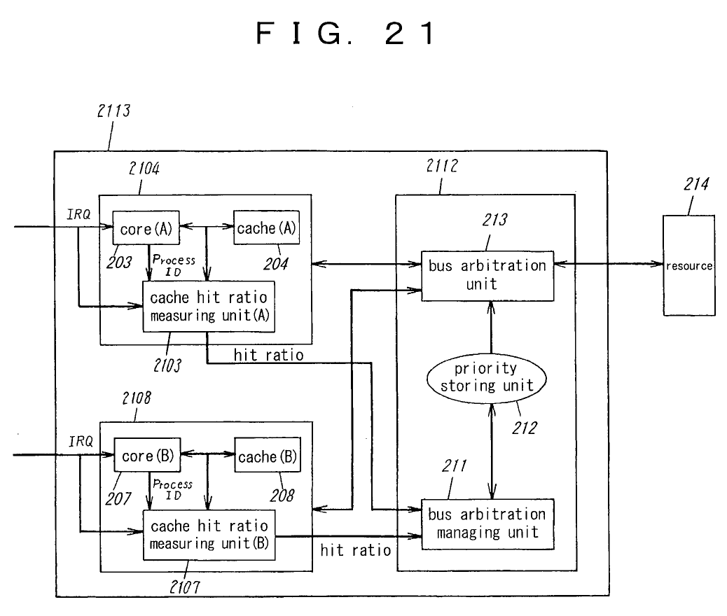

FIG. 21 shows an entire structure of a semiconductor apparatus according to an embodiment 8 of the present invention. A semiconductor apparatus 2113 comprises a bus master (A)2104, a bus master (B)2108 and a bus arbitration device 2112. The bus masters (A)2104 and (B)2108 share a resource 214 via the bus arbitration device 2112.

The bus master (A)2104 comprises a core (A)203, a cache (A)204 and a cache hit ratio measuring unit (A)2103. The bus master (B)2108 comprises a core (B)207, a cache (B)208 and a cache hit ratio measuring unit (B)2107.

The cache hit ratio measuring unit (A)2103 investigates and records a status of accesses made by the core (A)203 with respect to the cache (A)204 and the cache (B)208 to thereby measure the cache hit ratio of the core (A)203. The cache hit ratio measuring unit (B)2107 investigates and records a status of accesses made by the core (B)207 with respect to the cache (B)208 and the cache (A)204 to thereby measure the cache hit ratio of the core (B)207.

The bus arbitration device 2112 comprises a priority storing unit 212, a bus arbitration managing unit 211 and a bus arbitration unit 213. The bus arbitration managing unit 211 renews the priority in the priority storing unit 212 based on an information outputted from the cache hit ratio measuring units (A)2103 and (B)2107. The bus arbitration managing unit 211, the priority storing unit 212 and bus arbitration unit 213 are basically operated in the same manner as described in the embodiment 2.

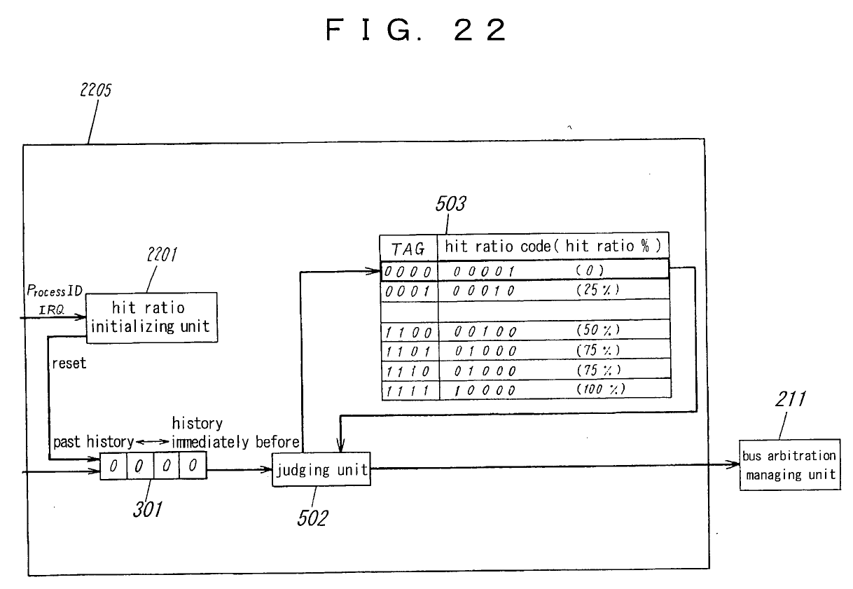

The embodiment 8 is characterized in constitutions of the cache hit ratio measuring unit (A)2103 and the cache hit ratio measuring unit (B)2107. More specifically, the cache hit ratio measuring units (A)2103 and (B)2107 according to the embodiment 8 are constituted in the same manner as a cache hit ratio measuring device 2205 shown in FIG. 22. The cache hit ratio measuring device 2205 comprises a hit ratio initializing unit 2201, a hit history register 301, a judging unit 502 and a hit ratio code table 503.

The operations of the hit history register 301, hit ratio code table 503 and judging unit 502 are as described in the embodiment 2. The embodiment 8 is characterized in that the hit ratio initializing unit 2201 is provided. More specifically, when a process request is made to the semiconductor apparatus 2113, ProcessID and IRQ of the process are supplied to the hit ratio initializing unit 2201. The hit ratio initializing unit 2201 detects a change of the processing executed by the core based on the ProcessID, and further, detects an interruption by another processing based on the IRQ. When these changes are detected, the hit ratio initializing unit 2201 initializes the value of the hit history register 301 to “0000”. The initialization is executed for the following reason. When the processing executed by the core is changed or the IRQ is generated, the bus masters (A)2104 and (B)2108 more necessarily accesses the resource 214. Based on the fact, the hit ratio initializing unit 2201 initializes the value of the hit history register 301 to “0000” to thereby improve an accuracy in changing the priority.

The ProcessID is inputted from the cores (A)203 and (B)207 to the cache hit ratio measuring units (A)2103 and (B)2107, while the IRQ is directly inputted the cache hit ratio measuring units (A)2103 and (B)2107 without involving the cores (A)203 and (B)207.

Though the ProcessID is issued both when the executed processing is changed and the interruption by another processing is generated, the hit ratio initializing unit 2201 initializes the value of the hit history register 301 to “0000” based on the detection of the IRQ when the interruption is generated. The initialization is executed for the following reason. The ProcessID resulting from the IRQ is issued after the IRQ. Therefore, the hit ratio initializing unit 2201 detects the generation of the interruption based on the detection of the IRQ faster than the detection of the interruption based on the ProcessID resulting from the IRQ.

When the hit ratio initializing unit 2201 is thus additionally provided with the function of detecting not only the ProcessID but also the IRQ, the value of the hit history register 2202 can be initialized before the detection of the ProcessID, which allows a preparation for any subsequent processing in an early stage.

When the processing to be executed is simply changed in the absence of the interruption, only the ProcessID is issued. Accordingly, the hit ratio initializing unit 2201 executes the initialization process adopted when the executed processing is changed based on the detection of the ProcessID.

In the foregoing manner, the generation of the cache refilling is detected in an early stage. As a result, a higher priority can be given in real time to the bus master in a higher need for the bus access.

### EMBODIMENT 9

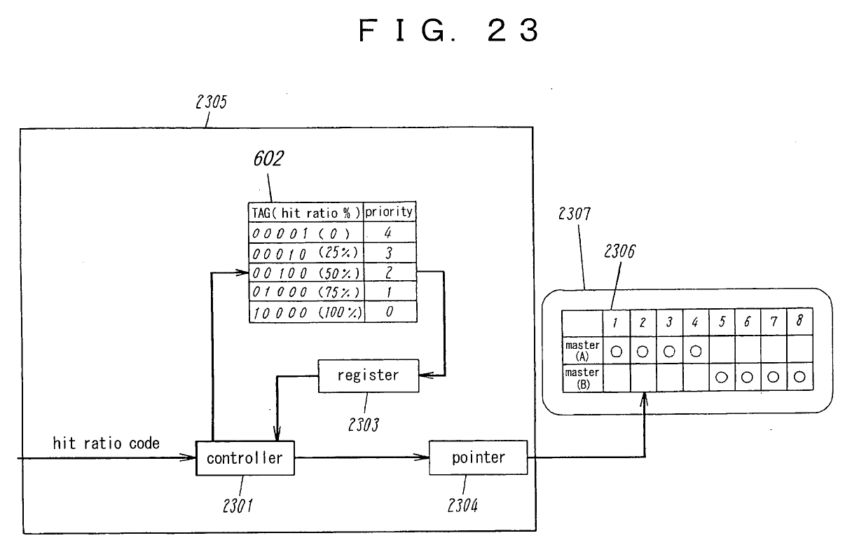

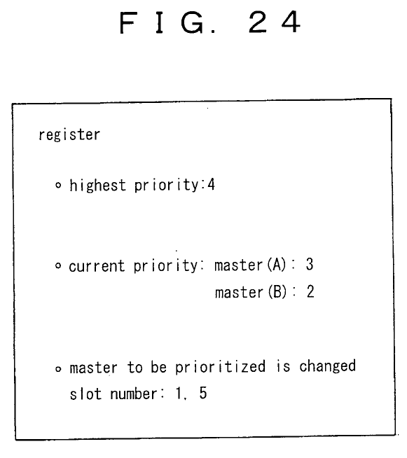

FIG. 2 shows an entire constitution of a semiconductor apparatus according to an embodiment 9 of the present invention. FIG. 23 shows constitutions of a bus arbitration managing unit 2305 and a priority storing unit 2307 according to the embodiment 9. The bus arbitration managing unit 2305 comprises a controller 2301, a priority conversion table 602, a register 2303 and a pointer 2304. The priority storing unit 2307 comprises a priority table 2306.

In the embodiment 9, the priority table 2306 in the priority storing unit 2307 is changed according to a method different to those described in the embodiments 1 through 8. In the embodiments 1 through 8, when the current priority table 401 is renewed, the priority is changed as described referring to FIG. 4. Then, the bus arbitration unit 213 references the current priority table 401 in the order of the slot number 1, then, 2, 3, . . . to thereby read the bus master to be prioritized in the relevant slot. After that, the bus arbitration unit 213 performs the bus arbitration in such manner that the bus access is made by the read bus master to be prioritized.

In contrast, the priority in the priority table 2306 according to the embodiment 9 is fixed in line with a highest priority in the priority conversion table 602 and never renewed. The bus arbitration managing unit 2305 comprising the pointer 2304 performs the bus arbitration based on the slot indicated by the pointer 2304. The pointer 2304 can arbitrarily change the indicated slot. More specifically, the pointer 2304 is adapted to change the indicated slot by jumping over the slots in such manner as the slots 1, 2, 5, . . . . Because the pointer 2304 is adapted in such a manner, the priority can be changed without the renewal of the priority table 2306 in the embodiment 9.

Next, operations of the respective components are described below. The controller 2301 reads the priority corresponding to the hit ratio code supplied from the cache hit ratio measuring units 205 and 209 from the priority conversion table 602 and outputs the read priority to the register 2303. The register 2303 retains a highest priority information of each bus master, a current priority information of each bus master and a slot number information for changing the bus master to be prioritized. The register 2303 rewrites the current priority information of each master based on the priority supplied from the priority conversion table 602.

For example, as shown in FIG. 23, when the highest priority in the priority conversion table 2302 indicates “4”, the highest priority information in the register 2303 indicates “4”. When the slot number in which the bus master to be prioritized in the priority table 2306 is 1 and 5, the slot number information that changes the bus master to be prioritized in the register 2303 indicates “1” and “5”. The controller 2301 reads the information in the register 2303 to thereby compare the slot number currently indicated by the pointer 2304 to the slot number information memorized in the register 2303 and judge which slot should be indicated next by the pointer 2304. The controller 2301 controls the pointer 2304 based on the judgment.

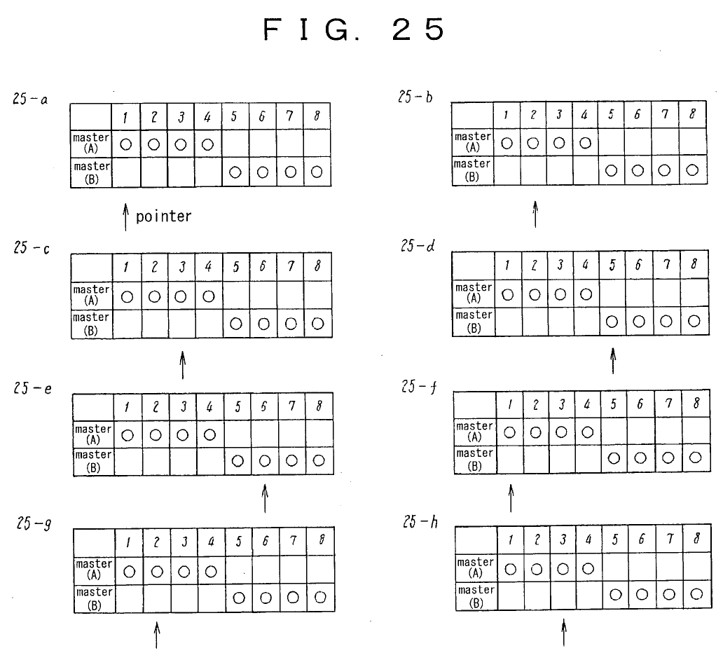

The control of the pointer 2304 by the controller 2301 is described further in detail referring FIGS. 24 and 25. In the example shown in FIG. 24, the highest priority is “4”, the current priority in the master (A) is “3”, and the current priority in the master (B) is “2” in the information memorized in the register 2303. Further, in the priority table 2306, the master (A) is prioritized in the slot numbers 1-4, while the master (B) is prioritized in the slot numbers 5-8.

In the case of no change in the priority, the pointer 2304 indicates the slot number as shown in FIG. 25. More specifically, the pointer 2304 serially indicates the slot numbers 1, 2 and 3 in accordance with the priority “3” of the master (A) as shown in 25-a, 25-b and 25-c. Next, the pointer 2304 judges that the priority of the master (A) has run out and jumps to the slot number 5 (25-d) in order to shift to the priority of the master (B). Then, the pointer 2304 serially indicates the slot numbers 5 and 6 (25-d and 25-e) in accordance with the priority 2 of the master (B). Next, the pointer 2304 judges that the priority of the master (B)has run out and jumps back to the slot number 1 (25-f) in order to shift to the priority of the master (A). The foregoing operation of the pointer 2304 is controlled by the controller 2301.

Because the operation of the pointer 2304 is thus controlled, a cycle in which the master (A) is consecutively prioritized three times and the master (B) is then consecutively prioritized twice is repeated.

In the case of any change in the priority, the controller 2301 controls the operation in such manner that the changed priority is adopted in and after the next cycle provided that the prioritized master of the slot indicated by the pointer 2304 coincides with the master in the changed priority when the priority is changed. When they do not coincide with each other, on the other hand, the changed priority is adopted at the time when and after the master to be prioritized is shifted.

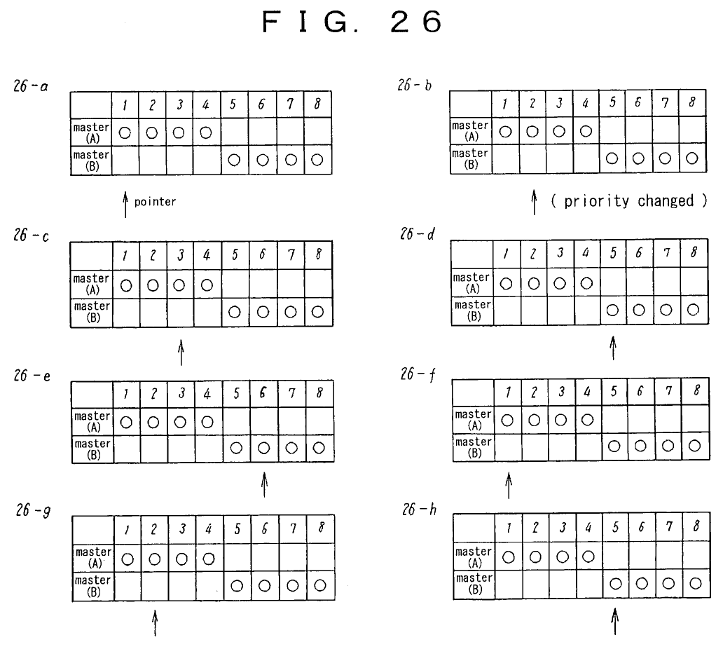

Below is described an example in which the bus arbitration managing unit 2305 changes the priority of the master (A) from “3” to “2” in the case where the indicated slot number is 2 and the master (A) is prioritized. Because the master (A) is prioritized in the slot number 2 as shown in FIG. 26, the current priority is followed until the repetition of a cycle is completed.

More specifically, after the slot number 2 (26-(b)), the pointer 2304 indicates the slot of the slot number 3 (26-c) in accordance with the current priority, then jumps to the slot number 5, and thereafter serially indicates the slot numbers 5 and 6 (26-d and 26-e). Then, the relevant cycle is terminated.

Next, given that the changed priority is applied when and after the pointer 2304 jumps to the slot number 1 (26-f), the priority of the master (A) is changed to “2”, and the priority of the master (B)to “2” at the time. Therefore, a cycle in which the slots indicated by the pointer 2304 are 1, 2, 5, . . . (26-f, 26-g, 26-h, . . . ) is repeated until the priority is changed.

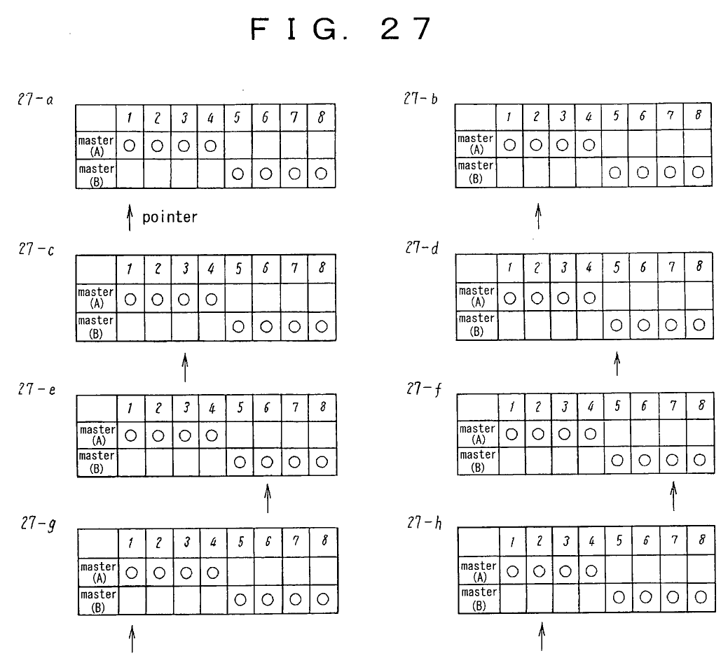

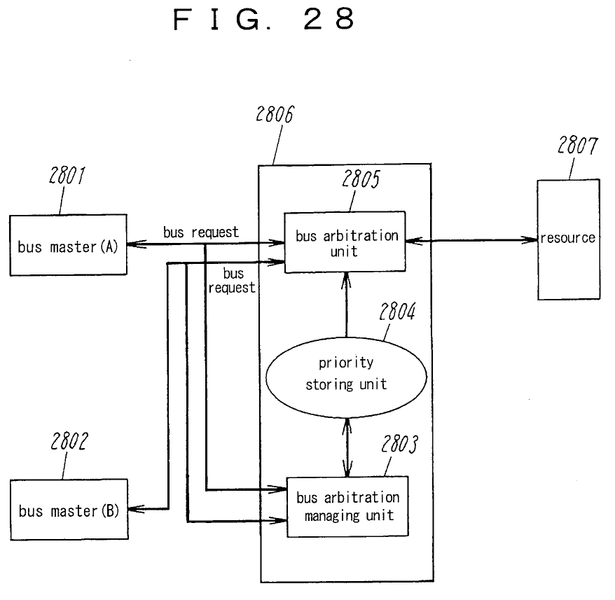

Below is described, referring to FIG. 27, an example where the priority is changed from “2” to “3” when the indicated slot number is 2, and the bus master (A) is prioritized. In this example, the changed priority is applied when and after the pointer 2304 indicates the next slot position where the master (B) is prioritized. More specifically, after the pointer indicates the slot numbers 1, 2, 3 (27-(a), 27-(b) and 27-(c), the pointer is controlled in such manner that the slot numbers 5, 7, 7, 1, 2, . . . (27-d, 27-e, 27-f, 27-g, 27-h, . . . ), instead of the slot numbers 5, 6, 1, are indicated as a result of the application of the changed priority when and after the bus master to be prioritized is switched (when the bus master to be prioritized is changed from the bus master (A) to the bus master (B).

As described, the pointer 2304 is jumped to change the indicated slot so that the priority is changed instead of the renewal of the priority table as described in the embodiments 1-8. According to the constitution, the effort of renewing the priority table can be saved, and the priority in the bus arbitration can be optimized in a shorter period of time.

The cache hit ratio measuring unit is constituted and the operations of the respective components are the same as described in the embodiment 2.

As a result of executing the processes described in detail in the embodiments 1-9, the priority in the bus arbitration can be obtained in real time based on the cache hit ratio, and the optimum bus arbitration can be thereby performed. Unless specified otherwise, the transfer method employed in the bus master in the embodiments is the burst transfer. The operations described in the embodiments 1-9 are not necessarily independent from one anther but can be flexibly combined and executed.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A semiconductor apparatus comprising:
at least two bus masters;
a cache hit ratio measuring device; and
a bus arbitration device, wherein
the bus masters each comprises a cache for temporarily storing data transmitted and received between themselves and at least a resource and share the resource via at least a bus,
the cache hit ratio measuring device calculates a hit ratio in accesses made to the cache included in at least one of the bus masters, and
the bus arbitration device performs bus arbitration between the bus masters and the resource based on the hit ratio calculated by the cache hit radio measuring device.

2. A semiconductor apparatus as claimed in claim 1, wherein
the cache hit ratio measuring device generates a bus priority lowering request or a bus priority raising request for the bus masters based on the hit ratio and outputs the generated request to the bus arbitration device, and
the bus arbitration device performs the bus arbitration between the bus masters and the resource based on the lowering request or the raising request.

3. A semiconductor apparatus as claimed in claim 2, wherein
the cache hit ratio measuring device comprises:
a cache access recording unit for recording an information on if the cache access is a hit or an error;
a first correspondence relation storing unit for storing a first correspondence relation between the information recorded in the cache access recording unit and the lowering request or the raising request; and
a judging unit for reading the lowering request or the raising request corresponding to the information recorded in the cache access recording unit from the first correspondence relation storing unit and outputting the read request to the bus arbitration device, wherein
the bus arbitration device performs the bus arbitration between the bus masters and the resource based on the lowering request or the raising request supplied from the judging unit.

4. A semiconductor apparatus as claimed in claim 2, wherein
the cache hit ratio measuring device comprises:
a cache access recording unit for recording an information on if the cache access is a hit or an error; and
a predicting unit for predicting the hit or the error of a next cache access based on the information recorded in the cache access recording unit and outputting the bus priority lowering request or the bus priority raising request to the bus arbitration device based on a result of the prediction; and
the bus arbitration device performs the bus arbitration between the bus masters and the resource based on the lowering request or the raising request supplied from the predicting unit.

5. A semiconductor apparatus as claimed in claim 4, wherein
the cache access recording device renews the information on if the cache access is the hit or the error every time when the cache access is generated.

6. A semiconductor apparatus as claimed in claim 2, wherein
the bus arbitration device comprises:
a priority storing unit for storing the bus priority;
a bus arbitration managing unit for changing the bus priority stored in the priority storing unit based on the lowering request or the raising request; and
a bus arbitration unit for performing the bus arbitration between the bus masters and the resource based on the bus priority read from the priority storing unit.

7. A semiconductor apparatus as claimed in claim 1, wherein
the cache hit ratio measuring device comprises:
a cache access recording unit for recording a history information on if the cache access is a hit or an error; and
a second correspondence relation storing unit for storing a second correspondence relation between the history information recorded in the cache access recording unit and the hit ratio of the cache accesses, and
the cache hit ratio measuring device reads the hit ratio corresponding to the history information recorded in the cache access recording unit from the second correspondence relation storing unit and outputs the read hit ratio to the bus arbitration device, and
the bus arbitration device performs the bus arbitration between the bus masters and the resource based on the hit ratio supplied from the cache hit ratio measuring device.

8. A semiconductor apparatus as claimed in claim 6, wherein
the bus arbitration device further comprises a third correspondence relation storing unit for memorizing a third correspondence relation between the hit ratio and the bus priority, and
the bus arbitration device reads the bus priority corresponding to the hit ratio supplied from the cache hit ratio measuring device from the third correspondence relation storing unit and performs the bus arbitration between the bus masters and the resource based on the read bus priority.

9. A semiconductor apparatus as claimed in claim 7, wherein
the cache hit ratio measuring device reads the hit ratios in the accesses made to the caches included in the at least two bus masters from the second correspondence relation storing unit,
the bus arbitration device further comprises a fourth correspondence relation storing unit for memorizing a fourth correspondence relation between a combination of the hit ratios in the at least two bus masters and a combination of the bus priorities in the at least two bus masters, and
the bus arbitration device reads the combination of the bus priorities corresponding to the combination of the hit ratios supplied from the cache hit ratio measuring device from the fourth correspondence relation storing unit and performs the bus arbitration between the bus masters and the resource based on the read combination of the bus priorities.

10. A semiconductor apparatus as claimed in claim 7, further comprising:
a plurality of the cache access recording units; and
a selecting unit for arbitrarily selecting any of the plurality of cache access recording units.

11. A semiconductor apparatus as claimed in claim 10, further comprising a current adjusting unit for restricting a current supply with respect to the cache access recording unit other than the cache access recording unit selected by the selecting unit.

12. A semiconductor apparatus as claimed in claim 8, further comprising a plurality of the third correspondence relation storing units; and
a selecting unit for arbitrarily selecting any of the plurality of third correspondence relation storing units.

13. A semiconductor apparatus as claimed in claim 12, further comprising a current adjusting unit for restricting a current supply with respect to the third correspondence relation storing unit other than the third correspondence relation storing unit selected by the selecting unit.

14. A semiconductor apparatus as claimed in claim 1, wherein
the cache hit ratio measuring device further comprises an initializing unit for initializing the cache hit measuring device when detecting a change in processes executed by the bus masters or an interruption signal.

15. A semiconductor apparatus as claimed in claim 1, wherein
the cache hit ratio measuring device further comprises a transfer method detecting unit for detecting a transfer method of the bus masters and notifying the bus arbitration device of a result of the detection, and
the bus arbitration device makes an additional adjustment to the bus arbitration based on the transfer method notified by the transfer method detecting unit.

16. A semiconductor apparatus as claimed in claim 2, wherein
the bus arbitration device comprises:
a priority storing unit for storing the bus priority in the form of a table format information; and
an indicator for indicating a designated point for reading the table in the priority storing unit in accordance with the hit ratio calculated by the cache hit ratio measuring device, and
the bus arbitration device reads the bus priority from the priority storing unit in accordance with the indication by the indicator and thereby performs the bus arbitration between the bus masters and the resource.

17. A bus arbitration method for a semiconductor apparatus, the semiconductor apparatus comprising:
at least two bus masters;
a cache hit ratio measuring device; and
a bus arbitration device, wherein
the bus masters each comprises a cache for temporarily storing data transmitted and received between themselves and at least a resource and share the resource via at least a bus, the bus arbitration method comprising:
a calculating step for calculating a hit ratio in accesses made to the cache included in at least one of the bus masters; and
an arbitrating step for performing bus arbitration between the bus masters and the resource based on the calculated hit ratio.

18. A bus arbitration method for a semiconductor apparatus as claimed in claim 17, wherein
a bus priority lowering request or a bus priority raising request for the bus masters is generated based on the calculated hit ratio in the calculating step, and
the bus arbitration is performed between the bus masters and the resource based on the lowering request or the raising request in the arbitrating step.

19. A bus arbitration method for a semiconductor apparatus as claimed in claim 18, wherein
the calculating step further includes:
a cache access recording step for recording an information on if the cache access is a hit or an error;
a first correspondence relation storing step for previously storing a first correspondence relation between the information recoded in the cache access recording step and the lowering request or the raising request; and
a judging step for reading the lowering request or the raising request corresponding to the information from the first correspondence relation, and
the bus arbitration is performed between the bus masters and the resource based on the lowering request or the raising request read in the judging step in the arbitrating step.

20. A bus arbitration method for a semiconductor apparatus as claimed in claim 18, wherein
the calculating step includes:
a cache access recording step for recording an information on if the cache access is a hit or an error; and
a predicting step for predicting the hit or the error of a next cache access based on the information and outputting the bus priority lowering request or the bus priority raising request based on a result of the prediction; and
the bus arbitration is performed between the bus masters and the resource based on the lowering request or the raising request outputted in the predicting step in the arbitrating step.

21. A bus arbitration method for a semiconductor apparatus as claimed in claim 19, wherein
the information on if the cache access is the hit or the error is renewed every time when the cache access is generated in the cache access recording step.

22. A bus arbitration method for a semiconductor apparatus as claimed in claim 18, wherein
the arbitrating step includes:
a step of changing the bus priority based on the bus priority lowering request or the bus priority raising request; and
a step of performing the bus arbitration between the bus masters and the resource based on the changed bus priority.

23. A bus arbitration method for a semiconductor apparatus as claimed in claim 17, wherein
the calculating step includes:
a step of recording a history information on if the cache access is a hit or an error; and
a step of recording a second correspondence relation between the hit ratio of the cache accesses and the history information, and
the hit ratio corresponding to the history information is read from the second correspondence relation in the calculating step, and
the bus arbitration is performed between the bus masters and the resource based on the hit ratio read in the calculating step in the arbitrating step.

24. A bus arbitration method for a semiconductor apparatus as claimed in claim 23, wherein
the arbitrating step further includes:
a step for memorizing a third correspondence relation between the hit ratio and the bus priority, and
the bus priority corresponding to the hit ratio read in the calculating step is read from the third correspondence relation and the bus arbitration is performed between the bus masters and the resource based on the read bus priority in the arbitrating step.

25. A bus arbitration method for a semiconductor apparatus as claimed in claim 23, wherein
the hit ratios in the accesses made to the caches included in the at least two bus masters are read from the second correspondence relation in the calculating step,
the arbitration step further includes a step of memorizing a correspondence relation between a combination of the hit ratios in the at least two bus masters and a combination of the bus priorities in the at least two bus masters, and
the combination of the bus priorities corresponding to the combination of the hit ratios read in the calculating step is read from the fourth correspondence relation and the bus arbitration is performed between the bus masters and the resource based on the read combination of the bus priorities in the arbitrating step.

26. A bus arbitration method for a semiconductor apparatus as claimed in claim 17, wherein
the calculating step further includes an initializing step for initializing the cache hit measuring device when a change in processes executed by the bus masters or an interruption signal is detected.

27. A bus arbitration method for a semiconductor apparatus as claimed in claim 17, wherein
the calculating step further includes a transfer method notifying step for detecting and notifying a transfer method of the bus masters, and
an additional adjustment is made to the bus arbitration based on the transfer method notified in the transfer method notifying step in the arbitrating step.
